(19) United States
(12) Patent Application Publication
(10) Pub. No.: US 2025/0355118 A1
(43) Pub. Date: Nov. 20, 2025

(54) METHOD AND SYSTEM FOR LEARNED POINT CLOUD AGGREGATION OF NON-SYNCHRONIZED MULTI-SENSOR FUSION

(71) Applicant: Torc Robotics, Inc., Blacksburg, VA (US)

(72) Inventor: Daniel Moodie, Henrico, VA (US)

(21) Appl. No.: 18/666,399

(22) Filed: May 16, 2024

(51) Int. Cl. G01S 17/89; G01S 7/48; G01S 17/931

(52) U.S. Cl. CPC G01S 17/89; G01S 7/4808; G01S 17/931

(57) ABSTRACT

A perception system is configured to: (i) initialize a grid with default values for a set of points in an environment of the perception system; (ii) based upon a first sensor data, identify a first subset of the set of points and features corresponding to a first point cloud; (iii) perform temporal alignment of the identified features corresponding to the first point cloud; (iv) update the grid using the temporally aligned features corresponding to the first point cloud; (v) based upon a second sensor data, identify a second subset of the set of points and features corresponding to a second point cloud; (vi) perform temporal alignment of the identified features corresponding to the second point cloud; and (vii) update the grid using the temporally aligned features corresponding to the second point cloud to display in a single reference frame with the temporally aligned features corresponding to the first point cloud.

### TECHNICAL FIELD

The field of the disclosure relates to a virtual driver for fusion and modeling using sensed and other information to create models and other outputs and, in particular, aggregation of learned point clouds by fusion of sensor data of multiple non-synchronized sensors.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies generally uses sensors like a camera, a radio detection and ranging (RADAR) sensor, a light detection and ranging (LiDAR) sensor for detecting the surrounding environment of the autonomous vehicle. One important aspect of detecting the surrounding environment of the autonomous vehicle includes aggregating point clouds generated from sensor data of a plurality of image sensors, a plurality of light detection and ranging (LiDAR) sensors, or a plurality of radio detection and ranging (RADAR) sensors. Conventional techniques for point cloud aggregation based upon sensor data of multiple sensors require assumptions to be made regarding point time delta corrections. Correcting time offsets across sensors either assume that the world is static and adjust all points accordingly which smears dynamic objects or assume that the world is dynamic which smears static objects. Additionally, conventional techniques for point cloud aggregation transform all sensor data to a single reference time, which causes per sensor sensing artifacts providing contextual information being lost.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a perception system including a plurality of sensors, at least one processor, and at least one memory storing instructions thereon is disclosed. The plurality of sensors includes a first sensor and a second sensor. The at least one processor is configured to executed the stored instructions to perform operations including (i) initializing a grid with default values for a set of points in an environment of a vehicle including the perception system; (ii) based upon sensor data received from the first sensor, identifying a first subset of the set of points corresponding to a first point cloud; (iii) identifying features corresponding to the first point cloud; (iv) performing temporal alignment of the identified features corresponding to the first point cloud; (v) updating the grid using the temporally aligned features corresponding to the first point cloud; (vi) based upon sensor data received from the second sensor, identifying a second subset of the set of points corresponding to a second point cloud; (vii) identifying features corresponding to the second point cloud; (viii) performing temporal alignment of the identified features corresponding to the second point cloud; and (ix) updating the grid using the temporally aligned features corresponding to the second point cloud to display in a single reference frame with the temporally aligned features corresponding to the first point cloud.

In another aspect, a computer-implemented method performed by a perception system is disclosed. The perception system includes a plurality of sensors including a first sensor and a second sensor, and at least processor configured to execute instructions stored in at least one memory. The method includes (i) initializing a grid with default values for a set of points in an environment of a vehicle including the perception system; (ii) based upon sensor data received from the first sensor, identifying a first subset of the set of points corresponding to a first point cloud; (iii) identifying features corresponding to the first point cloud; (iv) performing temporal alignment of the identified features corresponding to the first point cloud; (v) updating the grid using the temporally aligned features corresponding to the first point cloud; (vi) based upon sensor data received from the second sensor, identifying a second subset of the set of points corresponding to a second point cloud; (vii) identifying features corresponding to the second point cloud; (viii) performing temporal alignment of the identified features corresponding to the second point cloud; and (ix) updating the grid using the temporally aligned features corresponding to the second point cloud to display in a single reference frame with the temporally aligned features corresponding to the first point cloud.

In yet another aspect, an autonomous vehicle including a plurality of sensor, at least one memory storing instructions thereon, and at least one processor configured to execute the stored instructions is disclosed. The plurality of sensors includes a first sensor and a second sensor. The at least one processor is configured to perform operations including (i) initializing a grid with default values for a set of points in an environment of a vehicle including the perception system; (ii) based upon sensor data received from the first sensor, identifying a first subset of the set of points corresponding to a first point cloud; (iii) identifying features corresponding to the first point cloud; (iv) performing temporal alignment of the identified features corresponding to the first point cloud; (v) updating the grid using the temporally aligned features corresponding to the first point cloud; (vi) based upon sensor data received from the second sensor, identifying a second subset of the set of points corresponding to a second point cloud; (vii) identifying features corresponding to the second point cloud; (viii) performing temporal alignment of the identified features corresponding to the second point cloud; and (ix) updating the grid using the temporally aligned features corresponding to the second point cloud to display in a single reference frame with the temporally aligned features corresponding to the first point cloud.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is an example illustration of aggregation of point clouds in a single reference frame based on learned features of the point clouds; and

FIG. 5 is a flow-chart of method operations performed by a perception system shown in FIG. 2 or a computing system shown in FIG. 3.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

A point cloud: A point cloud is a set of data points generally represented in a three dimensional (3D) space for a 3D shape or object in an unstructured form. Data points in the point cloud may be generated based upon sensor data from one or more LiDAR sensors, one or more RADAR sensors, or one or more image sensors.

Non-synchronized sensors: Non-synchronized sensors in the present disclosure refer to sensors collecting sensor measurement data or sensor data at different times. For example, a first LiDAR sensor may collect sensor data at time t₀ then a second LiDAR sensor may collect sensor data at time t₁ (t₀+Δt), and a third LiDAR sensor may collect sensor data at time t₂ (t₀+Δt′). Accordingly, the first, second, and third LiDAR sensors are non-synchronized sensors. The non-synchronized sensors may be referenced herein as non-time synchronized sensors.

Pose estimation: Pose estimation is a task, for example, a computer vision task, to detect position and orientation of 3D shapes or objects captured in the point cloud based upon predicting locations of specific key points of the 3D shapes or objects. In the present disclosure, pose estimation may be an input raw sensor data or an output sensor data corresponding to a vehicle position or 3D shapes or objects in an environment of the vehicle.

Learned approach/Learned Detection: Learned approach, or learned detection, as referenced in the present disclosure, is a task that uses raw 3D data to learn about environment of the vehicle. In particular, the learned approach, learned detection, may be used to learn about objects such as, pedestrians, traffic signals, traffic lanes geometry, other vehicles, road geometry, or road surface, etc. in the environment of the vehicle.

In the present disclosure, various embodiments corresponding to learned point cloud aggregation are disclosed. Learned point cloud aggregation may be performed using a Spatio-Temporal Graph neural network (NN) by fusing data from multiple non-time synchronized sensors into a common representation, or a single reference frame, for various perception tasks. Currently known approaches of point cloud aggregation involve using an external sensor to estimate a transformation delta from a data sample to a reference time. The transformation delta is applied to the points of the data sample to account for motion of the vehicle since the reference time. This temporal alignment may be canonically referred to as motion compensation that is achieved via estimating a 3×3 rotation matrix (R) and a 3×1 translation vector (T), which may be applied to a matrix of points (X) and X′=R*X+T, which may also be formulated as a generalized matrix multiplication (GEMM). Estimation of R and T may be based upon an external source, for example, a wheel encoder or an inertial measurement unit (IMU). By transforming points X to X′, the points may become aligned. The aligned points may be concatenated with other similarly transformed points of the data sample to the single common reference frame. The naïve transformation of points according to currently known approaches of point cloud aggregation is based on an assumption that all points (in the environment of the vehicle) are stationary points, and, therefore, points associated with any moving targets may be blurred as they move between temporarily incoherent samples. Blurring of points associated with moving targets may cause artifacts that cannot be disambiguated without additional information, and therefore, various embodiments for learned point cloud aggregation are disclosed herein that reduce or eliminate artifacts based upon access to the pre-transformed information.

In some embodiments, a learned point cloud aggregation approach defined may use a spatial feature space of learned features to fuse points of various data samples together in a common reference frame. Instead of naively concatenating points to densify an environment, the learned point cloud aggregation approach described herein may transform input samples by a learnable function to convert raw sensor data into higher dimensional features. The input to this learnable function ƒ may take the form of Y=ƒ(Wᵢ, X, t, . . . ) where Wᵢ are learnable weights, X is a set of sample points, t is a timestamp offset between the given sample and the reference time, Y are the learned features. In some embodiments, and by way of a non-limiting example, the learnable function ƒ may take additional inputs such as, sensor specific parameters identifying a sensor type, a sensor configuration, a sensor origin or a sensor position on the vehicle, etc. The learned features can then be transformed by the same R and T transformations estimated for the conventional fusion approach. Since the learned features are derived from the learnable function ƒ that has access to additional information, the additional information may be propagated to downstream tasks including, but not limited to, an object detection task, a vehicle localization task, or a lane geometry estimator task, etc. The downstream tasks related to many autonomous vehicle tasks, 3D points may be projected onto a ground plane to create 2D features such as, birds-eye-view (BEV) features. BEV features form an image that appears from the bird's eye view perspective. Additionally, the R and T matrix and vector may be projected onto the ground plane to produce 2D variants.

Learned transformed features corresponding to points of data samples of multiple sensors may be aggregated in a single reference frame. An algorithm for aggregating transformed features corresponding to points of data samples of multiple sensors may initialize a N×M grid (G) of features with a default values. Points of data samples transformed into learned features (Y), using the learnable function ƒ, may be converted into the grid G by a learned function g that takes the form of G=g(Wⱼ, Y, G) where the function g is parameterized by learned weights Wⱼ which operate on both the current state of G and the input features Y. Accordingly, the algorithm considers the current state of the grid G when aggregating new features (Y). In some embodiments, and by way of a non-limiting example, the grid G may correspond with BEV features. This step, or function, g may be repeated iteratively for a pre-defined time window to aggregate learned features into the grid G. Upon lapse of the pre-defined time window, the grid G may include representative features from all data samples acquired during that time window from multiple sensors. The representative feature of the grid G may then be passed on to the downstream tasks described herein.

In some embodiments, raw sensor data may be converted into higher dimensional features using an algorithm or pseudo code described below.

```
def aggregateSamples(samples):
  G = zeros(M, N)
  for X, t, R, T in samples:
    Y = f(Wᵢ, X, t)
    Y′ = Y * R + T
    G = g(Wⱼ, Y′, G)
  return G
```

Additionally, or alternatively, the learned point cloud aggregation may be based upon initialization of the learned features from the previous timestamp with an additional set of learned parameters for fusing across aggregated features, as shown in another algorithm or pseudo code below.

```
def aggregateSamples(samples, G_previous):
  G = g′(Wk, G_previous)
  for X, t, R, T in samples:
      Y = f(Wᵢ, X, t)
      Y′ = f′(Y, R, T, G)
      G = g(Wⱼ, Y′, G)
    return G
```

In the above pseudo code, the aggregated features from a previous aggregation window G_previous are provided as input, these features are modulated by learned weights Wₖ and an aggregation modulation function g′ to form the initialization for the current frame. By way of a non-limiting example, aggregated features from the previous aggregation window G_previous may be spatially aligned to the current aggregation window.

In some embodiments, learned features for data samples of point clouds based upon row sensor data of multiple samples may be adjusted for artifacts, which may be due to effects of vehicle motion. For example, a first sensor may have measurement data for a static object identifying the static object is 10 meters away, and a second sensor may have measurement data for the static object identifying the static object is 8 meters away. When the point clouds of the first sensor and the second sensor are aggregated in a single reference frame, without the learned approach of point cloud aggregation as described herein, two different static objects instead of one static object may be presented in the single reference frame because the first sensor and the second sensor are non-time synchronized sensors. Additionally, or alternatively, artifacts may be due to non-static objects in the environment of the vehicle. Accordingly, the learned features may reduce or eliminate artifacts due to motion of the vehicle in which the sensors are positioned or due to motion of other objects in the environment of the vehicle.

In some embodiments, to determine artifacts and reduce or eliminate artifacts due to motion of other objects in the environment of the vehicle, a frequency modulated continuous wave (FMCW)-based LiDAR sensor may be used. FMCW-based LiDAR sensors may be used to measure velocity and motion of other objects in the environment of the vehicle. Traditional LiDAR sensors based on time-of-flight data may be used to detect objects in the environment of the vehicle. Additionally, or alternatively, FMCS-based LiDAR sensors or traditional LiDAR sensors may encode sensor ID in the light signal emitted by the LiDAR sensor. Accordingly, each data point in a point cloud may have a sensor ID associated as metadata. The sensor ID may be based on a sensor type, a sensor position or a location of the sensor on the vehicle, etc. The sensor ID encoded in the LiDAR signal may be used to query, for example, by a downstream task, point cloud data and based on differences in data corresponding to points in different point clouds for sensor data obtained at different times for the same sensor, specific nuances of the environment of the vehicle may be identified. In other words, the sensor ID encoded as metadata may identify a traversal path of the LiDAR signal, any occlusion of the LiDAR signal for points in different point clouds of the same LiDAR sensor at different times, or different LiDAR sensors.

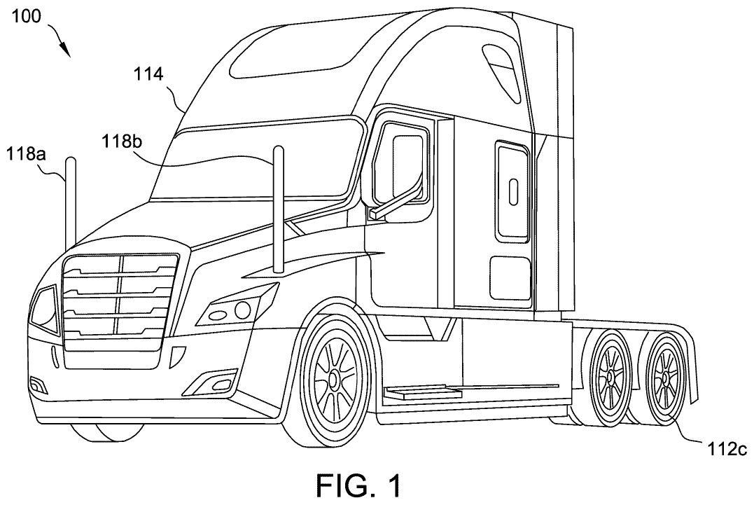

In some embodiments, aggregation of the learned features of point cloud data of multiple point clouds may be performed using a neural network such as, a transformer neural network, or a recurrent neural network. Various embodiments in the present disclosure are described with reference to FIGS. 1-5 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels, and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

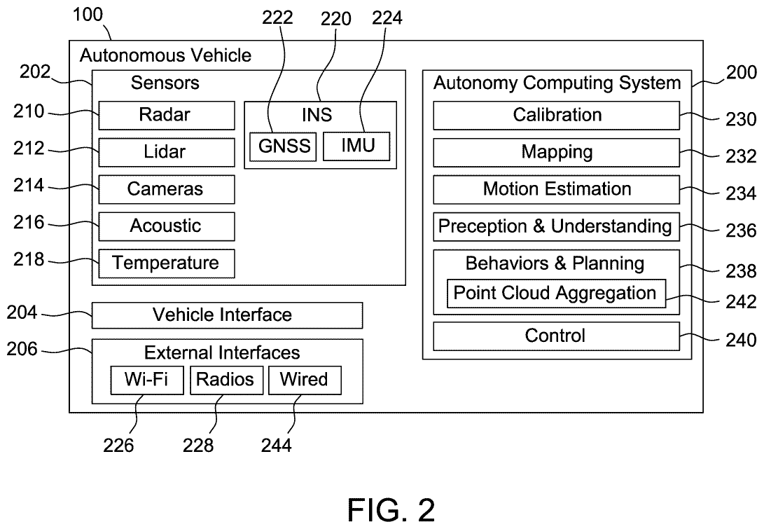

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 in multi-layer perception technologies of autonomous vehicle 100.

Cameras 214, LiDAR sensors 212, or RADAR sensors 210 are configured to capture sensor data for points in the environment surrounding autonomous vehicle 100 in any aspect, direction, or field of view (FOV). The FOV can have any angle or aspect such that data corresponding to points of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, multiple LiDAR sensors 212, or multiple RADAR sensors 210, and the data received from each of the multiple cameras 214, multiple LiDAR sensors 212, or multiple RADAR sensors 210 may be processed in perception technologies of autonomous vehicle 100. In some embodiments, the sensor data of the multiple cameras 214, multiple LiDAR sensors 212, or multiple RADAR sensors 210 may be sent to autonomy computing system 200 or other aspects of autonomous vehicle 100 for generating point clouds, identifying features of the generated point clouds, and aggregating point clouds based upon learned features of the point clouds, and transmitting data of the aggregated point clouds to downstream tasks or other modules of the autonomy computing system 200 or mission control or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. LiDAR sensors 212 may be traditional LiDAR sensors based on time-of-flight data, or LiDAR sensors 212 may be FMCS-based LiDAR sensors. Each of the LiDAR sensors 212 may encode a sensor ID such that data corresponding to each point may include the sensor ID as metadata. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. Each of the RADAR sensors 210 may encode a sensor ID such that data corresponding to each point may include the sensor ID as metadata.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical system (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a point cloud aggregation module 242. The point cloud aggregation module 242, for example, may be embodied within another module, such as perception and understanding module 236 or behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

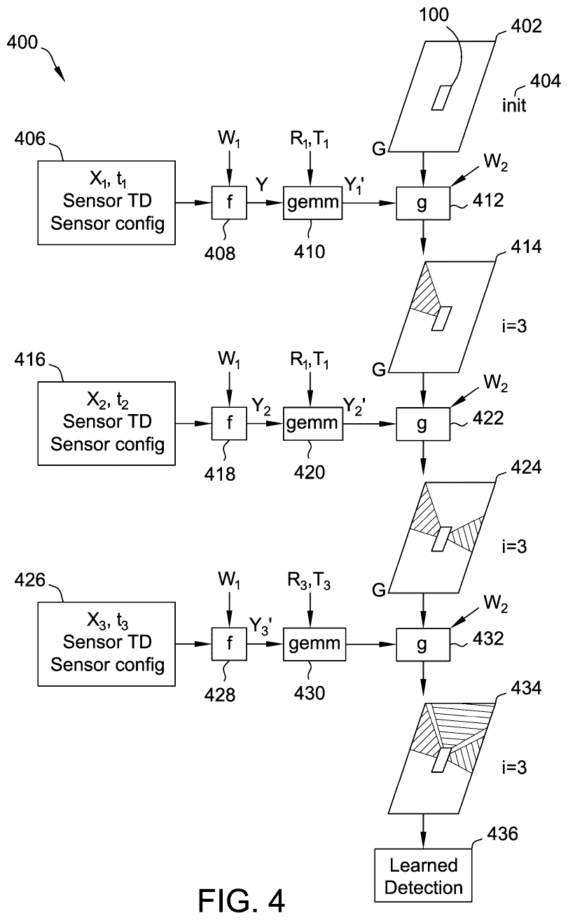

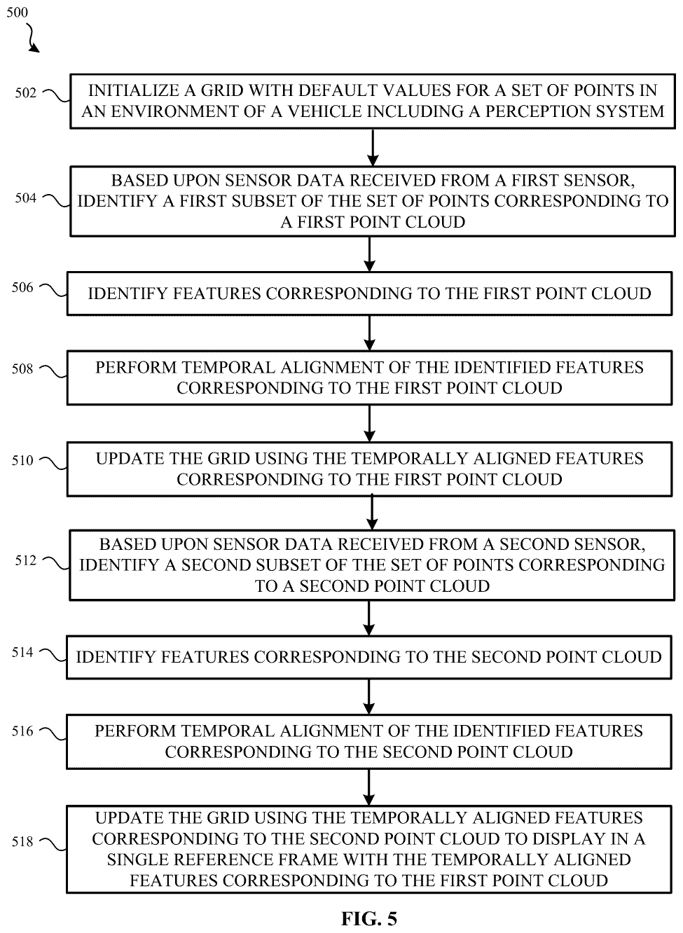

The point cloud aggregation module 242 may perform one or more tasks including, but not limited to, generating point clouds, identifying features of the generated point clouds, and aggregating point clouds based upon learned features of the point clouds, and transmitting data of the aggregated point clouds to downstream tasks or other modules of the autonomy computing system 200 or mission control or both. Tasks performed by the point cloud aggregation module 242 are described in detail using FIG. 4 and FIG. 5 below.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

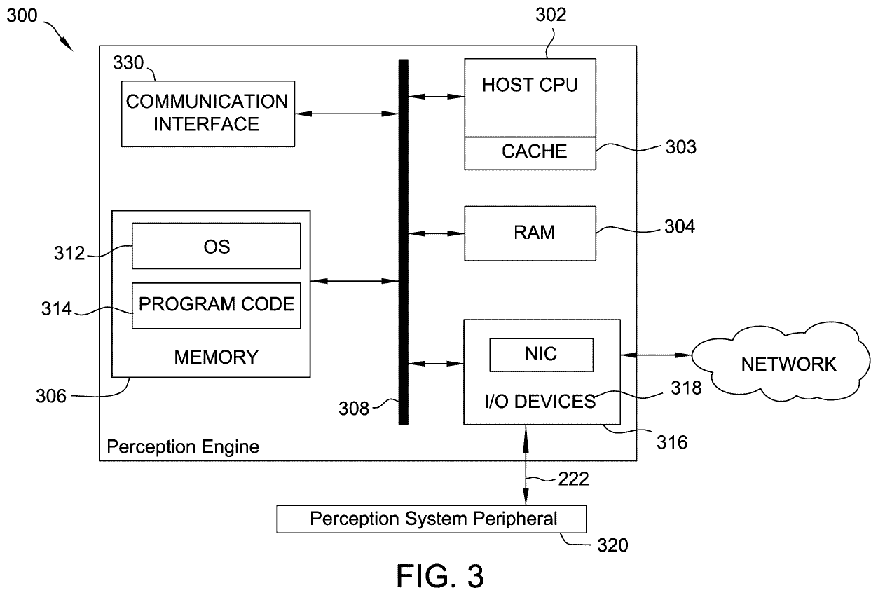

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

FIG. 4 is an example illustration 400 of aggregation of point clouds in a single reference frame based on learned features of the point clouds as described herein. As described herein, learned features corresponding to points of data samples of multiple sensors are aggregated in a single reference frame. As shown in FIG. 4, autonomous vehicle 100 is shown in a N×M grid (G) 402. The N×M grid 402 may be initialized 404; in other words, all points in the N×M grid 402 may be set to have their respective 2D or 3D data coordinate values set to zero. Autonomous vehicle 100 may be installed with multiple LiDAR sensors 212, multiple RADAR sensors 210, or multiple cameras 214, which may be non-time synchronized sensors as described herein. By way of a non-limiting example, autonomous vehicle 100 may be installed with a first LiDAR sensor to capture data for points in the left of autonomous vehicle 100, a second LiDAR sensor to capture data for points in the right of autonomous vehicle 100, and a third LiDAR sensor to capture data for points in the front of autonomous vehicle 100. Because, the first LiDAR sensor, the second LiDAR sensor, and the third LiDAR sensor are non-time synchronized sensors, raw sensor data may be received at different times from the first LiDAR sensor, the second LiDAR sensor, and the third LiDAR sensor.

In some embodiments, and by way of a non-limiting example, at time t₁, sensor data 406 from the first LiDAR sensor may be received for a first set of points X₁ in the left of autonomous vehicle 100. Sensor data 406 received from the first LiDAR sensor may include a sensor ID corresponding to the first LiDAR sensor. As described herein, the sensor ID may identify the first LiDAR sensor based upon one or more of a sensor type, a location, or a configuration of the first LiDAR sensor. The raw sensor data 406 may be processed through a learnable function ƒ 408 that may take the form of Y₁=ƒ(W₁, X₁, t₁, . . . ) where W₁ are learnable weights, X₁ is a set of sample points, t₁ is a timestamp offset between the given sample and the reference time for which data points of different points are being aggregated, and Y₁ corresponds with the learned features for the point cloud X₁. A generalized matrix multiplication (GEMM) 410 may be then derived from the learned features Y₁, a 3×3 rotation matrix (R₁) and a 3×1 translation vector (T₁) as Y₁′=Y₁*R₁+T₁, which may be applied to a function g 412 to present the point cloud X₁ on the grid G 402 according to g(W₂, Y₁′, G) where the function g 412 is parameterized by learned weights W₂ which operate on both the current state of G and the input features Y₁′. The resultant grid G may be as shown in FIG. 4 as 414, which shows or presents points in the point cloud X₁ based upon the learned features of from the point cloud X₁.

In some embodiments, and by way of a non-limiting example, at time t₂, sensor data 416 from the second LiDAR sensor may be received for a second set of points X₂ in the right of autonomous vehicle 100. Sensor data 416 received from the second LiDAR sensor may include a sensor ID corresponding to the second LiDAR sensor. As described herein, the sensor ID may identify the second LiDAR sensor based upon one or more of a sensor type, a location, or a configuration of the second LiDAR sensor. The raw sensor data 416 may be processed through a learnable function ƒ 418 that may take the form of Y₂=ƒ(W₁, X₂, t₂, . . . ) where W₁ are learnable weights, X₂ is a set of sample points, t₂ is a timestamp offset between the given sample and the reference time for which data points of different points are being aggregated, and Y₂ corresponds with the learned features for the point cloud X₂. A generalized matrix multiplication (GEMM) 420 may be then derived from the learned features Y₂, a 3×3 rotation matrix (R)) and a 3×1 translation vector (T₁) as Y₂′=Y₂*R₁+T₁, which may be applied to a function g 422 to present the point cloud X₂ on the grid G 414 according to g(W₂, Y₂′, G) where the function g 412 is parameterized by learned weights W₂ which operate on both the current state of G and the input features Y₂′. The resultant grid G may be as shown in FIG. 4 as 424, which shows or presents points in the point clouds X₁ and X₂ based upon the learned features of from the point clouds X₁ and X₂ in a single reference frame.

In some embodiments, and by way of a non-limiting example, at time t₃, sensor data 426 from the third LiDAR sensor may be received for a third set of points X₃ in the front of autonomous vehicle 100. Sensor data 426 received from the third LiDAR sensor may include a sensor ID corresponding to the third LiDAR sensor. As described herein, the sensor ID may identify the third LiDAR sensor based upon one or more of a sensor type, a location, or a configuration of the first LiDAR sensor. The raw sensor data 426 may be processed through a learnable function ƒ 428 that may take the form of Y₃=ƒ(W₁, X₃, t₃, . . . ) where W₁ are learnable weights, X₃ is a set of sample points, t₃ is a timestamp offset between the given sample and the reference time for which data points of different points are being aggregated, and Y₃ corresponds with the learned features for the point cloud X₃. A generalized matrix multiplication (GEMM) 430 may be then derived from the learned features Y₃, a 3×3 rotation matrix (R₁) and a 3×1 translation vector (T₁) as Y₃′=Y₃*R₁+T₁, which may be applied to a function g 432 to present the point cloud X₃ on the grid G 402 according to g(W₂, Y₃′, G) where the function g 432 is parameterized by learned weights W₂ which operate on both the current state of G and the input features Y₃′. The resultant grid G may be as shown in FIG. 4 as 434, which shows or presents points in the point clouds X₁, X₂, and X₃ based upon the learned features of from the point clouds X₁, X₂, and X₃ in a single reference frame.

Data corresponding to aggregated point clouds X₁, X₂, and X₃ in a single reference frame may be transmitted to downstream tasks 436 including, but not limited to, an object detection task, a vehicle localization task, or a lane geometry estimator task, etc.

FIG. 5 is an example flow-chart 500 of method operations performed by a perception system, for example, the autonomy computing system 200 or its modules (shown in FIG. 2). As described herein, the perception system may include a plurality of sensors including at least a first sensor and a second sensor. The method operations may include initializing 502 a grid with default values for a set of points in an environment of a vehicle including the perception system. The vehicle may be an autonomous vehicle or a semi-autonomous vehicle. The grid may be initialized, as described herein with regards to FIG. 4, and hence details corresponding to initializing 502 the grid is not described again for brevity. The first sensor and the second sensor may be non-synchronized sensors and based upon sensor data received from the first sensor, a first subset of the set of points corresponding to a first point cloud may be identified 504. Further, features corresponding to the first point cloud may be identified 506 and temporal alignment of the identified features may be performed 508 corresponding to the first point cloud, as described in detail with regards to FIG. 4. Using the temporally aligned features corresponding to the first point cloud, the grid may be updated 510, as described herein.

Based upon sensor data received from the second sensor, a second subset of the set of points corresponding to a second point cloud may be identified 512. Further, features corresponding to the second point cloud may be identified 514 and temporal alignment of the identified features may be performed 516 corresponding to the second point cloud, as described in detail with regards to FIG. 4. Using the temporally aligned features corresponding to the second point cloud, the grid may be updated 518, as described herein, to display the temporally aligned features corresponding to the first point cloud and the second point cloud in a single reference frame.

An example technical effect of the methods, systems, and apparatus described herein includes at least availability of incrementally updated learned representation based on sensor data that can be used by downstream tasks for training machine learning algorithms related to perception technologies.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A perception system, comprising:
a plurality of sensors including a first sensor and a second sensor; and
at least one processor configured to execute instructions stored in at least one memory to perform operations comprising:
initializing a grid with default values for a set of points in an environment of a vehicle including the perception system;
based upon sensor data received from the first sensor, identifying a first subset of the set of points corresponding to a first point cloud;
identifying features corresponding to the first point cloud;
performing temporal alignment of the identified features corresponding to the first point cloud;
updating the grid using the temporally aligned features corresponding to the first point cloud;
based upon sensor data received from the second sensor, identifying a second subset of the set of points corresponding to a second point cloud;
identifying features corresponding to the second point cloud;
performing temporal alignment of the identified features corresponding to the second point cloud; and
updating the grid using the temporally aligned features corresponding to the second point cloud to display in a single reference frame with the temporally aligned features corresponding to the first point cloud.

2. The perception system of claim 1, wherein the grid displays the temporally aligned features corresponding to the second point cloud and the first point cloud in a single reference frame as bird's-eye-view features.

3. The perception system of claim 1, wherein the first sensor or the second sensor is a light detection and ranging (LiDAR) sensor.

4. The perception system of claim 3, wherein the LiDAR sensor is a frequency modulated continuous wave-based LiDAR sensor.

5. The perception system of claim 1, wherein the sensor data includes a respective sensor identification (ID) of the first sensor or the second sensor.

6. The perception system of claim 5, wherein the respective sensor ID is associated with a sensor type or a position of a sensor on the vehicle.

7. The perception system of claim 1, wherein the operations further comprising storing data corresponding to the single reference frame including the temporally aligned features corresponding to the first point cloud and the second point cloud for access or query by a downstream task.

8. The perception system of claim 7, wherein the downstream task includes at least one of an object detection task, a lane geometry detection task, or a vehicle localization task.

9. A computer-implemented method performed by a perception system, the perception system comprises a plurality of sensors including a first sensor and a second sensor, and at least one processor configured to execute instructions stored in at least one memory, the method comprising:
initializing a grid with default values for a set of points in an environment of a vehicle including the perception system;
based upon sensor data received from the first sensor, identifying a first subset of the set of points corresponding to a first point cloud;
identifying features corresponding to the first point cloud;
performing temporal alignment of the identified features corresponding to the first point cloud;
updating the grid using the temporally aligned features corresponding to the first point cloud;
based upon sensor data received from the second sensor, identifying a second subset of the set of points corresponding to a second point cloud;
identifying features corresponding to the second point cloud;
performing temporal alignment of the identified features corresponding to the second point cloud; and
updating the grid using the temporally aligned features corresponding to the second point cloud to display in a single reference frame with the temporally aligned features corresponding to the first point cloud.

10. The computer-implemented method of claim 9, wherein the grid displays the temporally aligned features corresponding to the second point cloud and the first point cloud in a single reference frame as bird's-eye-view features.

11. The computer-implemented method of claim 9, wherein the first sensor or the second sensor is a light detection and ranging (LiDAR) sensor.

12. The computer-implemented method of claim 11, wherein the LiDAR sensor is a frequency modulated continuous wave-based LiDAR sensor.

13. The computer-implemented method of claim 9, wherein the sensor data includes a respective sensor identification (ID) of the first sensor or the second sensor.

14. The computer-implemented method of claim 13, wherein the respective sensor ID is associated with a sensor type or a position of a sensor on the vehicle.

15. The computer-implemented method of claim 9, further comprising storing data corresponding to the single reference frame including the temporally aligned features corresponding to the first point cloud and the second point cloud for access or query by a downstream task.

16. The computer-implemented method of claim 15, wherein the downstream task includes at least one of an object detection task, a lane geometry detection task, or a vehicle localization task.

17. An autonomous vehicle, comprising:
a plurality of sensors including a first sensor and a second sensor;
at least one memory storing instructions thereon; and
at least one processor configured to execute the instructions to perform operations comprising:
initializing a grid with default values for a set of points in an environment of a vehicle including the perception system;
based upon sensor data received from the first sensor, identifying a first subset of the set of points corresponding to a first point cloud;
identifying features corresponding to the first point cloud;
performing temporal alignment of the identified features corresponding to the first point cloud;
updating the grid using the temporally aligned features corresponding to the first point cloud;
based upon sensor data received from the second sensor, identifying a second subset of the set of points corresponding to a second point cloud;
identifying features corresponding to the second point cloud;
performing temporal alignment of the identified features corresponding to the second point cloud;
updating the grid using the temporally aligned features corresponding to the second point cloud to display in a single reference frame with the temporally aligned features corresponding to the first point cloud.

18. The autonomous vehicle of claim 17, wherein:
the grid displays the temporally aligned features corresponding to the second point cloud and the first point cloud in a single reference frame as bird's-eye-view features;
the sensor data includes a respective sensor identification (ID) of the first sensor or the second sensor; and
the respective sensor ID is associated with a sensor type or a position of a sensor on the autonomous vehicle.

19. The autonomous vehicle of claim 17, wherein the first sensor or the second sensor is a light detection and ranging (LiDAR) sensor, and wherein the LiDAR sensor is a frequency modulated continuous wave-based LiDAR sensor.

20. The autonomous vehicle of claim 17, wherein the operations further comprising storing data corresponding to the single reference frame including the temporally aligned features corresponding to the first point cloud and the second point cloud for access or query by a downstream task, and wherein the downstream task includes at least one of an object detection task, a lane geometry detection task, or a vehicle localization task.
